(19) United States
(12) Patent Application Publication
(10) Pub. No.: US 2016/0381120 A1
(43) Pub. Date: Dec. 29, 2016

(54) SYSTEM FOR EVENT DISSEMINATION

(71) Applicant: INTEL CORPORATION, Santa Clara, CA (US)

(72) Inventors: MARIO FLAJSLIK, Hudson, MA (US); JAMES DINAN, Hudson, MA (US); KEITH UNDERWOOD, Albuquerque, NM (US)

(73) Assignee: INTEL CORPORATION, Santa Clara, CA (US)

(21) Appl. No.: 14/748,763

(22) Filed: Jun. 24, 2015

(51) Int. Cl. H04L 29/08; G06F 9/54; H04L 12/911

(52) U.S. Cl. CPC H04L 67/10; H04L 67/26; H04L 47/70; G06F 9/542; G06F 9/546

(57) ABSTRACT

This disclosure is directed to a system for event dissemination. In general, a system may comprise a plurality of devices each including an event dissemination module (EDM) configured to disseminate events between the plurality of devices. New events may be generated during the normal course of operation in each of the plurality of devices. These events may be provided to at least one device designated as a network dispatch location. The network dispatch location may initiate the dissemination of the events. For example, each device may place received events into a local event queue within the device. The placement of an event into the local event queue may cause a counter in the EDM to increment. Incrementing the counter may, in turn, cause a trigger operation module in the EDM to perform at least one activity including, for example, forwarding the event to other devices within the plurality of devices.

### GOVERNMENT CONTRACT

This invention was made with Government support under contract number H98230-13-D-0124 awarded by the Department of Defense. The Government has certain rights in this invention.

### TECHNICAL FIELD

The present disclosure relates to inter-device communication, and more particularly, to offloading the dissemination of events in a multi-device architecture to a hardware-based system.

### BACKGROUND

As the applications to which computing resources may be applied become more plentiful, so do the variety of computing architectures that may be implemented for these applications. For example, emerging scalable computing systems may comprise a plurality of separate computing devices (e.g., nodes) that may be configured to operate alone or collaboratively to solve complex problems, process large amounts of data, etc. This organization of computing resources may be deemed a high performance computing (HPC) architecture. HPC architectures are able to attack large jobs by breaking the large job into a variety of smaller tasks. The smaller tasks may then be assigned to one or more computing devices in the HPC architecture. When the processing of a smaller task is complete, the result may be returned to at least one master device that may, for example, organize the results of the smaller tasks, send out the results of the smaller tasks to one or more computing devices to perform the next data processing operation, integrate the results of the smaller tasks to generate a result for the larger job, etc. HPC architectures are beneficial at least in that the data processing power of individual computing devices may be concentrated in a quasi-parallelized manner that may be readily scalable to a particular data processing application.

While the various benefits of the above example of collaborative data processing may be apparent, there may be some challenges to operating a collaborative computing architecture. An example system may comprise a plurality of processing nodes each with different characteristics (e.g., processor type, processing power, available storage, different equipment, etc.). Each of the nodes may participate in processing a large job by performing smaller tasks that contribute to the large job. Differently-configured nodes performing different tasks may generate a variety of asynchronous events. An asynchronous event may be expected or unexpected (e.g., occurring at a time that may not be predictable). Examples of asynchronous events may include, but are not limited, processing completion notifications, error notifications, equipment failure notifications, flow control notifications, etc. Asynchronous events may originate anywhere, may occur anytime and must be provided to at least nodes in the system that may be affected by the event.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for event dissemination in accordance with at least one embodiment of the present disclosure;

FIG. 2 illustrates an example configuration for a device usable in accordance with at least one embodiment of the present disclosure;

FIG. 3 illustrates an example configuration for an event dissemination module (EDM) and example interaction that may occur between the EDM and other modules in a device in accordance with at least one embodiment of the present disclosure; and

FIG. 4 illustrates example operations for event dissemination in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a system for event dissemination. In general, a system may comprise a plurality of devices each including an event dissemination module (EDM) configured to disseminate events between the plurality of devices. New events may be generated during the normal course of operation in each of the plurality of devices. These events may be provided to at least one device designated as a network dispatch location. The network dispatch location may initiate the dissemination of the events. For example, each device may place received events into a local event queue within the device. The placement of an event into the local event queue may cause a counter in the EDM to increment. Incrementing the counter may, in turn, cause a trigger operation module in the EDM to perform at least one activity including, for example, forwarding the event to other devices within the plurality of devices. In at least one embodiment, resources may exist in the plurality of devices to support multiple dispatch paths for allowing events to be disseminated in different ways (e.g., to different device groups, in a different device order, etc.).

In at least one embodiment, an example device to operate in a system for event dissemination may comprise at least a communication module, a processing module, a local event queue and an EDM. The communication module may be to interact with a plurality of other devices. The processing module may be to process at least events. The EDM may be to receive an event into the device, place the event into the local event queue and disseminate the event from the local event queue to at least one other device in the plurality of other devices.

In at least one embodiment, the processing module may be to generate a new event in the device and cause the communication module to transmit the new event to at least one device in the plurality of devices that is designated as a network dispatch location. The local queue may, for example, reside in a memory in the event dissemination module or in a memory module in the device. The EDM may comprise, for example, at least a counter to increment when an event is placed into the local event queue. The EDM may also comprise at least a trigger operation module to perform at least one activity when the counter increments. The at least one activity may comprise disseminating the event from the local event queue to at least one other device in the plurality of other devices. In disseminating the event, the EDM may be to cause the communication module to transmit a message including the event to the at least one other device. The device may further comprise at least one of a plurality of event dissemination modules or a plurality of local event queues corresponding to a plurality of event dispatch paths, respectively. The plurality of event dispatch paths may each define a group of the plurality of devices through which events are disseminated.

Consistent with the present disclosure, a system for event dissemination may comprise a plurality of devices, each of the plurality of devices comprising a communication module to interact with other devices in the plurality of devices, a processing module to process at least events, a local event queue and an EDM to receive an event into the device, place the event into the local event queue and disseminate the event from the local event queue to at least one other device in the plurality of other devices. The system may be, for example, a high performance computing (HPC) system. At least one device in the plurality of devices may be designated as a network dispatch location to which new events are transmitted for dissemination. Each EDM may comprise, for example, at least a counter to increment when an event is placed into the local event queue. Each EDM may further comprise at least a trigger operation module to perform at least one activity when the counter increments. The at least one activity may comprise, for example, disseminating the event from the local event queue to at least one other device in the plurality of other devices. Consistent with the present disclosure, an example method for event dissemination may comprise receiving an event in a device, placing the event in a local queue in the device and causing an event dissemination module in the device to disseminate the event from the local event queue to at least one other device.

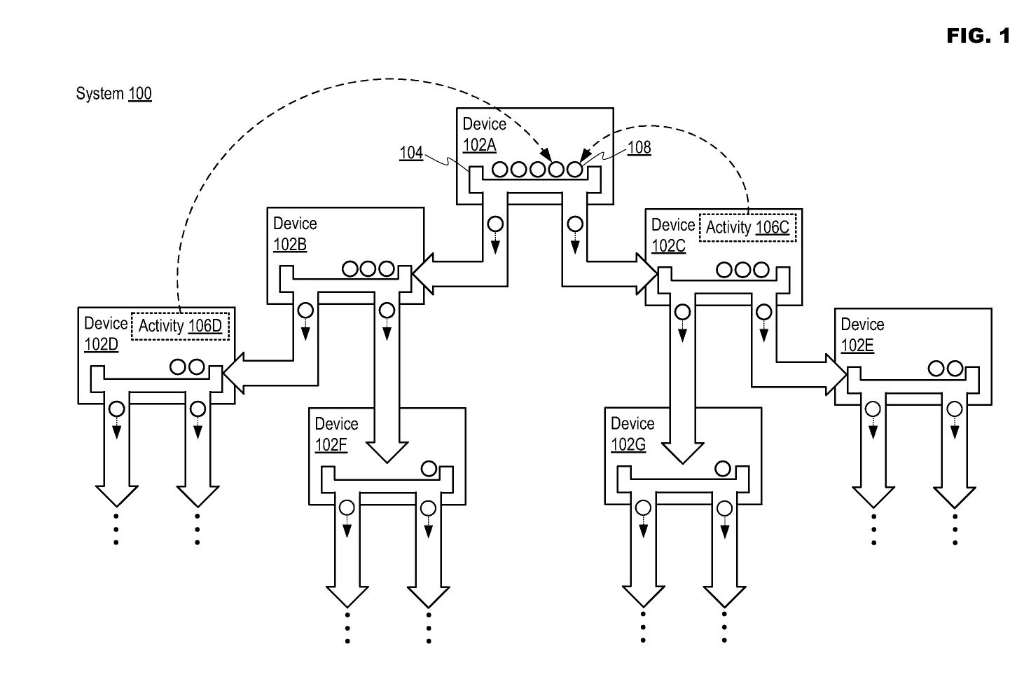

FIG. 1 illustrates an example system for event dissemination in accordance with at least one embodiment of the present disclosure. System 100 is illustrated as comprising a plurality of devices that may include, for example, device 102A, device 102B, device 102C, device 102D, device 102E, device 102F and device 102G (collectively, “devices 102A . . . G”). While seven (7) devices 102A . . . G are shown in FIG. 1, implementations of system 100 may comprise a smaller or larger number of devices 102A . . . G. Examples of devices 102A . . . G may include, but are not limited to, a mobile communication device such as a cellular handset or a smartphone based on the Android® operating system (OS) from the Google Corporation, iOS® or Mac OS® from the Apple Corporation, Windows® OS from the Microsoft Corporation, Tizen® OS from the Linux Foundation, Firefox® OS from the Mozilla Project, Blackberry@ OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc. Devices 102A . . . G in system 100 may be similarly configured or may be completely different devices. For the sake of explanation herein, an example implementation that may be utilized to better comprehend the various embodiments consistent with the present disclosure may include a rack or blade server installation wherein groups of servers are installed within a common chassis and linked by at least one network. In an example HPC computing environment, these groups of servers may be organized as a cluster with at least one master to manage operation of the cluster.

Existing systems for disseminating events within a collaborative computing environment are limited in that they require the operation of the devices within the computing environment to change to accommodate event notification. For example, event dissemination utilizing existing systems may take place via software-based messaging implemented by the main OS of a device 102A . . . G in which the event was generated, or through software-organized collective behavior. Requiring a device 102A . . . G to transmit event notifications to other devices 102A . . . G that may be interested in the event may place a substantial amount of processing and/or communication overhead on the device, and thus, may impact device performance, longevity, etc. A collective operation such as, for example, a broadcast collective operation defined in the Message Passing Interface (MPI) standard (http://www.mpi-forum.org/docs/mpi-3.0/mpi30-report.pdf) works by implementing a software collective function in devices 102A . . . G wherein the event messages may not be allowed to progress until devices 102A . . . G call a particular function (e.g., a function that causes events to be delivered). In this manner, an asynchronous event can be “converted” into a synchronous event in that system 100 is forced to operate around the event. This forced synchronization of devices 102A . . . G interrupts operation of each device 102A . . . G, and thus, may negatively impact the overall operation of system 100.

Consistent with the present disclosure, system 100 is configured to disseminate events in a manner that is not disruptive to the individual operation of devices 102A . . . G. Dedicated event handling resources 104 in each device 102A . . . G may be responsible to receive and disseminate events throughout system 100. In at least one embodiment, event handling resources 104 may be implemented in hardware (e.g., firmware) so that operation may take place independently of OS-related and application-related operations that may also be occurring in devices 102A . . . G. In an example of operation, activities occurring in devices 102A . . . G, such as activity 106C in device 102C and activity 106D in device 102D may generate events 108. Activities 106C and 106D may be attributable to, for example, applications, utilities, services, etc. executing in devices 102C or 102D, the completion of a task related to a larger processing job being processed by system 100, a software error, an equipment failure, a flow control message, etc. In another example, device 102D may experience a software error or equipment failure and generate event 108 to notify other devices 102A . . . G in system 100 of the problem (e.g., so that corrective action may be taken). Events 108 may be forwarded to a network dispatch location. As referenced herein, a network dispatch location may be at least one device in system 100 configured to receive new events for dissemination throughout system 100. In the example of FIG. 1 device 102A is a network dispatch location. Event handling resources 104 in device 102A may receive and disseminate each event 108 (e.g., may dispatch each event 108 to devices 102B and 102C). In a similar manner, event handling resources in device 102B and device 102C may dispatch each event 108 to device 102D, device 102E, device 102F and device 102G. In this manner, device 102A . . . G may be arranged (e.g., in a binary tree or another topology) so that events provided to device 102A (e.g., the dispatch location) may flow downward through devices 102A . . . G. In at least one embodiment, event handling resources 104 may be separate from event processing that takes place in devices 102A . . . G. This means that event dissemination may be separate from any operations that may occur in devices 102A . . . G in response to a particular event 108.

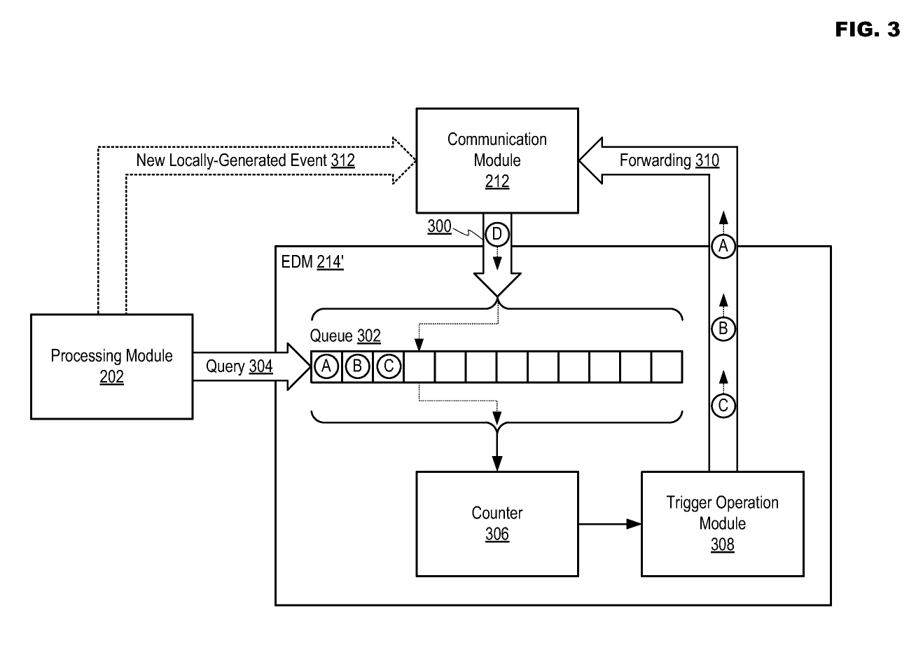

Consistent with the present disclosure, multiple dispatch paths may be defined in system 100. As referenced herein, a dispatch path may dictate the particular devices 102A . . . G to which event 108 will be disseminated (e.g., device 102B, device 102D, etc.) and/or the order of devices 102A . . . G through which event 108 will be disseminated (e.g., device 102A then device 102B then device 102D, etc.). Multiple dispatch paths may be employed when, for example, an event 108 is important only to certain devices 102A . . . G, when the dissemination of event 108 is time-sensitive for certain devices 102A . . . G, etc. Examples of methodologies and/or equipment for implementing multiple dispatch paths will be described in more detail with respect to FIG. 3.

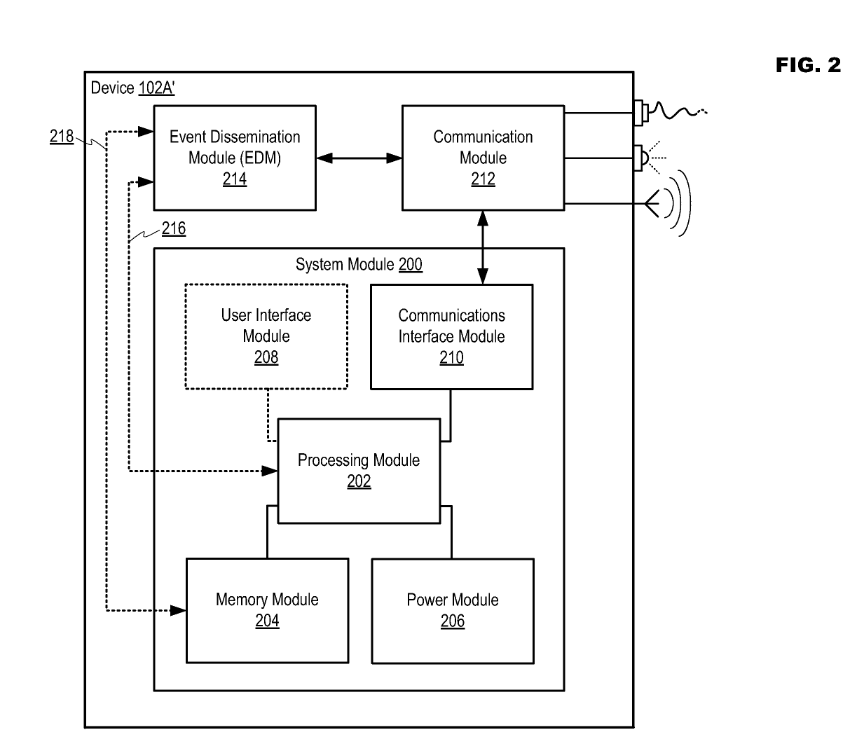

FIG. 2 illustrates an example configuration for a system usable in accordance with at least one embodiment of the present disclosure. The inclusion of an apostrophe after an item number (e.g., 100′) in the present disclosure may indicate that an example embodiment of the particular item is being illustrated. For example, device 102A′ may be capable of performing any or all of the activities disclosed in FIG. 1. However, device 102A′ is presented herein only as an example of an apparatus usable in embodiments consistent with the present disclosure, and is not intended to limit any of the various embodiments disclosed herein to any particular manner of implementation. Moreover, while an example configuration for device 102A′ is illustrated in FIG. 2, any or all of devices 102B . . . G may be configured in the same or a similar manner.

Device 102A′ may comprise, for example, system module 200 to manage operation of the device. System module 200 may include, for example, processing module 202, memory module 204, power module 206, user interface module 208 and communication interface module 210. Device 102A′ may further include communication module 212 and EDM 214. While communication module 212 and EDM 214 are illustrated as separate from system module 200, the example configuration shown in FIG. 2 has been provided herein merely for the sake of explanation. Some or all of the functionality associated with communication module 212 and EDM 214 may also be incorporated into system module 200.

In device 102A′, processing module 202 may comprise one or more processors situated in separate components, or alternatively one or more processing cores in a single component (e.g., in a system-on-chip (SoC) configuration), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102A′. Moreover, some or all of the functionality commonly associated with the support circuitry may also be included in the same physical package as the processor (e.g., such as in the Sandy Bridge family of processors available from the Intel Corporation).

Processing module 202 may be configured to execute various instructions in device 102A′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) and/or read-only memory (ROM) in a fixed or removable format. RAM may include volatile memory configured to hold information during the operation of device 102A′ such as, for example, static RAM (SRAM) or Dynamic RAM (DRAM). ROM may include non-volatile (NV) memory modules configured based on BIOS, UEFI, etc. to provide instructions when device 102A′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power module 206 may include internal power sources (e.g., a battery, fuel cell, etc.) and/or external power sources (e.g., electromechanical or solar generator, power grid, external fuel cell, etc.), and related circuitry configured to supply device 102A′ with the power needed to operate. User interface module 208 may include hardware and/or software to allow users to interact with device 102A′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in user interface module 208 may be incorporated within device 102A′ and/or may be coupled to device 102A′ via a wired or wireless communication medium. User interface module 208 may be optional in certain circumstances such as, for example, a situation wherein device 102A′ is a server (e.g., rack server, blade server, etc.) that does not include user interface module 208, and instead relies on another device (e.g., a management terminal) for user interface functionality.

Communication interface module 210 may be configured to manage packet routing and other control functions for communication module 212, which may include resources configured to support wired and/or wireless communications. In some instances, device 102A′ may comprise more than one communication module 212 (e.g., including separate physical interface modules for wired protocols and/or wireless radios) managed by a centralized communication interface module 210. Wired communications may include serial and parallel wired mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth, WLAN, Wi-Fi, etc.), long range wireless mediums (e.g., cellular wide-area radio communication technology, satellite-based communications, etc.), electronic communications via sound waves, etc. In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission. While the embodiment disclosed in FIG. 2 illustrates communication interface module 210 being separate from communication module 212, it may also be possible for the functionality of communication interface module 210 and communication module 212 to be incorporated into the same module. Moreover, in another embodiment it may be possible for communication interface module 210, communication module 212 and processing module 202 to be incorporated in the same module.

Consistent with the present disclosure, EDM 214 may utilize communication module 212 to receive events 108 from, and disseminate events 108 to, other devices 102B . . . G operating in system 100. Acting in this manner, EDM 214 and communication module 212 may provide the general functionality described in regard to event handing resources 104. When device 102A′ is designated as a network dispatch location, events 108 may be generated within device 102A′ or received from other devices 102B . . . G via communication module 212. Following processing such as will be described in regard to FIG. 3, EDM 214 may cause communication module 212 to forward events 108 to other devices 102B . . . G. Part of this functionality may include storing received events 108 in a local event queue (hereafter, “queue”), an example of which is disclosed at 302 in FIG. 3. Consistent with the present disclosure, queue 302 may reside within a memory inside of EDM 214 or within general device memory (e.g., memory module 204). If queue 302 resides within EDM 214, then as shown at 216 processing module 202 may interact with EDM 214 to, for example, query the local event queue for events 108 that may be relevant to device 102A′. In an instance where an event 108 in queue 302 is determined to be relevant to device 102A′, processing module 202 may process event 108, which may involve performing at least one activity in response to event 108 (e.g., requesting data from another device 102B . . . G that has acknowledged completion of a processing task, performing corrective action in response to an error, reassigning a processing task in regard to an equipment failure, etc.). In an example configuration where queue 302 resides in memory module 204, then EDM 214 may also interact with memory module 204, as shown at 218, to at least place received events 108 into queue 302.

FIG. 3 illustrates an example configuration for an event dissemination module (EDM) and example interaction that may occur between the EDM and other modules in a device in accordance with at least one embodiment of the present disclosure. With respect to FIG. 3, the disclosure may make reference to programmatic structures defined in the Portals specification (http://www.cs.sandia.gov/Portals/portals4-spec.html), and more particularly in the OpenMPI implementation over Portals (http://www.cs.sandia.gov/Portals/portals4-libs.html). Consistent with the present disclosure, the elements depicted in FIG. 3 may be used to efficiently implement flow control event dissemination in OpenMPI over Portals. While OpenMPI over Portals is able to employ a broadcast tree having a fixed root to alert nodes of a flow control event, such an implementation cannot support disseminating data as part of an event (not even the source of the event), and thus, Portals is limited only to disseminating flow control events. In addition, Portals may only support receiving one event at a time before software gets involved. Implementations consistent with the present disclosure may disseminate events 108 comprising data such as event identification (event_id) and may allow for the asynchronous reception of multiple events 108.

EDM 214′ may comprise, for example, local event queue 302, counter 306 and trigger operation module 308. In at least one embodiment, queue 302 may be a memory buffer with an offset that may be managed locally by a network interface such as, for example, communications interface module 210 and/or communication module 212. In OpenMPI over Portals terminology, an application program interface (API) utilized to manage queue 302 may be a PTL_ME_MANAGE_LOCAL type of match entry. Counter 306 may be attached to queue 302 and may count the number of events 108 received into the queue. Events 108 may be messages comprising a small fixed size structure, and thus, all events 108 appended into queue 302 may be of the same size. Counter 306 may be configured to interact with trigger operation module 308. Trigger operation module 308 may comprise at least one triggered operation (e.g., PtlTriggeredPut( ) operations in OpenMPI over Portals terminology). The triggered “puts” may be configured to execute on each increment of counter 306. The source buffer for the triggered put may be set to an entry in queue 302 corresponding to the counter value at which the put triggers. The destination for each triggered put operation (e.g., at least one device 102A . . . G) may be predetermined based on the particular topology used.

An example of operation will now be disclosed in regard to FIG. 3. New events may be received via communication module 212 as shown at 300. At various times (e.g., periodically, based on the reception of a new event, etc.) processing module 202 (e.g., or an application being executed by processing module 202) may query queue 302 to check for new events 108 as shown at 304. Processing module 202 may react to events that are determined to be relevant to the local device. In one embodiment, confirmation of a locally generated event 108 being disseminated in system 100 may be realized when processing module 202 determines that an event 108 added to queue 302 through dissemination operations originated locally (e.g., event 108 has come “full circle”). As events 108 (e.g., A, B, C, D) are placed into queue 302, counter 306 may increment. As counter 302 increments, triggered operations in trigger operation module 308 may cause the events to be forwarded to other modules as shown at 310. Also illustrated in FIG. 3, processing module 202 may generate events 108 locally, and may forward locally-generated events 108 to communication module 212, as shown at 312, for transmission to a network dispatch location.

In practical applications consistent with the present disclosure, all event messages may be required to be the same size and smaller than the max_waw_ordered_size, as defined in Portals, which may be the rendezvous size cutoff (e.g. 4 kB). A Host Fabric Interface (HFI) may be, for example, an instance of communications interface module 210 and/or communication module 212 (e.g., possibly in the form of a network interface card or “NIC”), and may provide ordering guarantees that are strong enough for this mechanism to always work. However, some HFIs might not be able to provide a guarantee of success, even if the mechanism almost always works. In such instances, queue 302 may be pre-initialized to a known value (e.g., all zeroes). Some event values may be reserved to indicate invalid events. In the unlikely case of an invalid event, a correct value may be recovered by re-reading the event either from queue 302, or from a queue at the network dispatch location (e.g., device 102A). Embodiments consistent with the present disclosure may also provide a way to efficiently implement an OpenSHMEM event extension (www.openshmem.org) that is based on Cray's SHMEM Event extension. In most use cases, event 108 may originate in software. However, it is possible to implement embodiments consistent with the present disclosure to handle hardware events. For example, a triggered put may be employed to initiate hardware-based event dissemination. In at least one embodiment, the devices 102A . . . G to which events 108 are disseminated (e.g., via triggered operations) may be configured in firmware. Thus, trigger operation module 308 may be at least partially firmware, and reconfiguration of a dispatch path may require initialization of a device 102A . . . G in which trigger operation module 308 resides. The dynamic configuration of dispatch paths may be performed in devices 102A . . . G by, for example, configuring resources in devices 102A . . . G to recognize or ignore events 108 based on origin, type, criticality, etc. In this manner, devices 102A . . . G may be configured to disseminate or ignore certain events 108.

In at least one embodiment, more than one dispatch path may be implemented in system 100 potentially covering different subsets of devices 102A . . . G. In this manner, multiple publish subscription pattern (pub-sub) networks may be implemented. Multiple dispatch paths may be implemented using a variety of different mechanisms. For example, different devices 102A . . . G may serve as network dispatch locations for different dispatch paths. Events 108 that are to be disseminated to a subset of devices 102A . . . G may be transmitted to a network dispatch location corresponding to the certain subset of devices 102A . . . G. Alternatively, multiple instances of EDM 214′, or at least queue 302, corresponding to multiple dispatch paths may reside in devices 102A . . . G. For example, an event 108 may be received by a certain instance of EDM 214′ or may be placed into a certain queue 302 corresponding to a targeted subset of devices 102A . . . G. As counter 306 increments, triggered operations may execute relative to the certain instance of EDM 214′ or queue 302 to disseminate event 108 to the targeted subset of devices 102A . . . G.

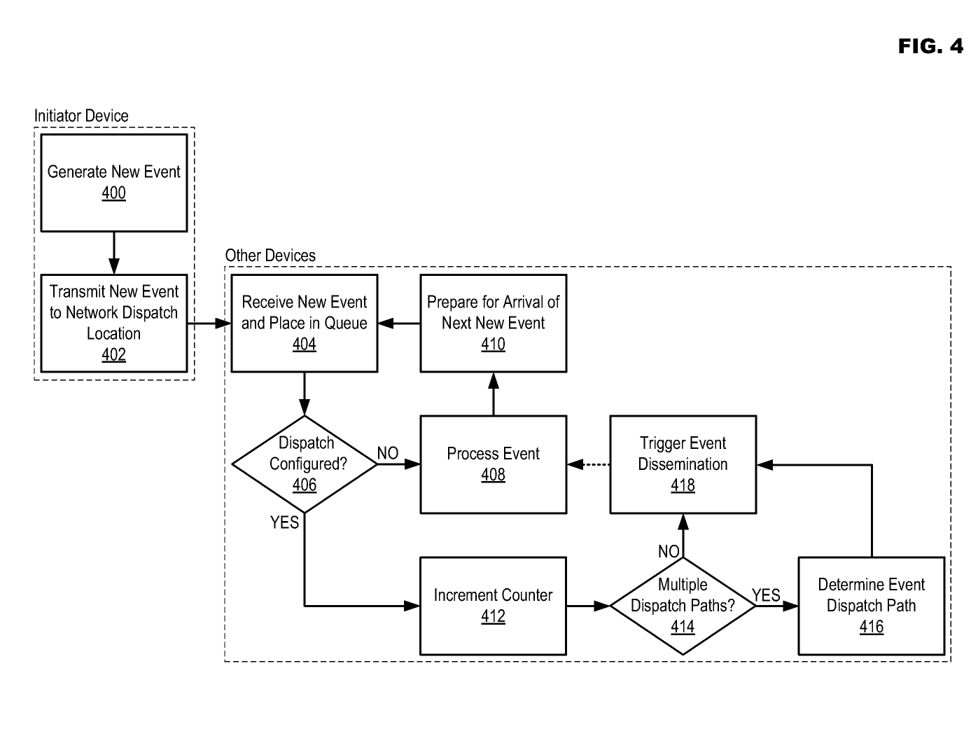

FIG. 4 illustrates example operations for event dissemination in accordance with at least one embodiment of the present disclosure. Operations 400 and 402 may occur in an “initiator” device (e.g., a device where an event originates) in a system comprising a plurality of devices. In operation 400 a new event may be generated in the initiator device. The new event may then be transmitted to a network dispatch location in operation 402. Operation 404 to 416 may occur in other devices within the system. In operation 404 a new event may be received in a device and placed in a queue. A determination may be made in operation 406 as to whether the device is configured to dispatch events. For example, a device that is at the bottom of a binomial tree structure formed with the devices in the system may not be configured to disseminate events. If in operation 406 it is determined that dispatch is not configured in the device, then in operation 408 the device may process any events in the queue that are relevant locally (e.g., to the device itself) and may prepare for the arrival of the next new event in operation 410. Operation 410 may be followed by a return to operation 404 when a new event in received in the device.

If in operation 406 it is determined that dispatch is configured, then in operation 412 a counter in the device may be incremented and in operation 414 a further determination may be made as to whether multiple dispatch paths are configured in the device. If in operation 414 it is determined that multiple dispatch paths are configured, then in operation 416 a particular event dispatch path to utilize for the event received in operation 404 may be determined. A particular event dispatch may be determined based on, for example, a particular subset of devices in the system to which the event to be disseminated may be relevant. Following a determination in operation 414 that multiple dispatch paths do not exist in the device, or alternatively following operation 416, in operation 418 event dissemination may be triggered (e.g., at least one trigger operation may occur). Event dissemination in operation 418 may optionally be followed by a return to operation 408 to process events residing in the queue.

While FIG. 4 illustrates operations according to an embodiment, it is to be understood that not all of the operations depicted in FIG. 4 are necessary for other embodiments. Indeed, it is fully contemplated herein that in other embodiments of the present disclosure, the operations depicted in FIG. 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry.

The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to a system for event dissemination. In general, a system may comprise a plurality of devices each including an event dissemination module (EDM) configured to disseminate events between the plurality of devices. New events may be generated during the normal course of operation in each of the plurality of devices. These events may be provided to at least one device designated as a network dispatch location. The network dispatch location may initiate the dissemination of the events. For example, each device may place received events into a local event queue within the device. The placement of an event into the local event queue may cause a counter in the EDM to increment. Incrementing the counter may, in turn, cause a trigger operation module in the EDM to perform at least one activity including, for example, forwarding the event to other devices within the plurality of devices.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for event dissemination.

According to example 1 there is provided a device to operate in a system for event dissemination. The device may comprise a communication module to interact with a plurality of other devices, a processing module to process at least events, a local event queue and an event dissemination module to receive an event into the device, place the event into the local event queue and disseminate the event from the local event queue to at least one other device in the plurality of other devices.

Example 2 may include the elements of example 1, wherein the processing module is to generate a new event in the device and cause the communication module to transmit the new event to at least one device in the plurality of devices that is designated as a network dispatch location.

Example 3 may include the elements of any of examples 1 to 2, wherein the local queue resides in a memory in the event dissemination module or in a memory module in the device.

Example 4 may include the elements of any of examples 1 to 3, wherein the event dissemination module comprises at least a counter to increment when an event is placed into the local event queue.

Example 5 may include the elements of any of examples 1 to 4, wherein the event dissemination module comprises at least a trigger operation module to perform at least one activity when the counter increments.

Example 6 may include the elements of example 5, wherein the at least one activity comprises disseminating the event from the local event queue to at least one other device in the plurality of other devices.

Example 7 may include the elements of any of examples 5 to 6, wherein the trigger operation module comprises at least one trigger operation implemented based on an OpenMPI implementation over Portals specification.

Example 8 may include the elements of any of examples 1 to 7, wherein in disseminating the event the event dissemination module is to cause the communication module to transmit a message including the event to the at least one other device.

Example 9 may include the elements of any of examples 1 to 8, wherein the device comprises at least one of a plurality of event dissemination modules or a plurality of local event queues corresponding to a plurality of event dispatch paths, respectively.

Example 10 may include the elements of example 9, wherein the plurality of event dispatch paths each define a group of the plurality of devices through which events are disseminated.

Example 11 may include the elements of any of examples 1 to 10, wherein the event dissemination module comprises at least a counter to increment when an event is placed into the local event queue and a trigger operation module to perform at least one activity when the counter increments.

Example 12 may include the elements of any of examples 1 to 11, wherein the events are asynchronous events.

Example 13 may include the elements of any of examples 1 to 12, wherein the events are implemented via an OpenSHMEM extension.

Example 14 may include the elements of any of examples 1 to 13, wherein the event dissemination module is based on at least one of hardware or firmware.

According to example 15 there is provided a system for event dissemination. The system may comprise a plurality of devices, each of the plurality of devices comprising a communication module to interact with other devices in the plurality of devices, a processing module to process at least events, a local event queue and an event dissemination module to receive an event into the device, place the event into the local event queue and disseminate the event from the local event queue to at least one other device in the plurality of other devices.

Example 16 may include the elements of example 15, wherein the system is a high performance computing system.

Example 17 may include the elements of any of examples 15 to 16, wherein at least one device in the plurality of devices is designated as a network dispatch location to which new events are transmitted for dissemination.

Example 18 may include the elements of any of examples 15 to 17, wherein each event dissemination module comprises at least a counter to increment when an event is placed into the local event queue.

Example 19 may include the elements of example 18, wherein each event dissemination module comprises at least a trigger operation module to perform at least one activity when the counter increments.

Example 20 may include the elements of example 19, wherein the at least one activity comprises disseminating the event from the local event queue to at least one other device in the plurality of other devices.

Example 21 may include the elements of any of examples 19 to 20, wherein the trigger operation module comprises at least one trigger operation implemented based on an OpenMPI implementation over Portals specification.

Example 22 may include the elements of any of examples 15 to 21, wherein the events are asynchronous events.

Example 23 may include the elements of any of examples 15 to 22, wherein the events are implemented via an OpenSHMEM extension.

Example 24 may include the elements of any of examples 15 to 23, wherein the event dissemination module is based on at least one of hardware or firmware.

According to example 25 there is provided a method for event dissemination. The method may comprise receiving an event in a device, placing the event in a local queue in the device and causing an event dissemination module in the device to disseminate the event from the local event queue to at least one other device.

Example 26 may include the elements of example 25, and may further comprise processing the event utilizing a processing module in the device.

Example 27 may include the elements of any of examples 25 to 26, wherein causing the event dissemination module in the device to disseminate the event comprises incrementing a counter when the event is placed into the local queue.

Example 28 may include the elements of example 27, wherein causing the event dissemination module in the device to disseminate the event comprises determining if multiple event dispatch paths exist in the device and if multiple event dispatch paths are determined to exist in the device, determining at least one event dispatch path to utilize in disseminating the event.

Example 29 may include the elements of any of examples 27 to 28, wherein causing the event dissemination module in the device to disseminate the event comprises triggering event dissemination operations based on incrementing the counter.

Example 30 may include the elements of any of examples 25 to 29, wherein causing the event dissemination module in the device to disseminate the event comprises incrementing a counter when the event is placed into the local queue and triggering event dissemination operations based on incrementing the counter.

Example 31 may include the elements of any of examples 25 to 30, wherein the events are asynchronous events.

According to example 32 there is provided a system including at least one device, the system being arranged to perform the method of any of the above examples 25 to 31.

According to example 33 there is provided a chipset arranged to perform the method of any of the above examples 25 to 31.

According to example 34 there is provided at least one machine readable medium comprising a plurality of instructions that, in response to be being executed on a computing device, cause the computing device to carry out the method according to any of the above examples 25 to 31.

According to example 35 there is provided at least one device to operate in a system for event dissemination, the device being arranged to perform the method of any of the above examples 25 to 31.

According to example 36 there is provided a system for event dissemination. The system may comprise means for receiving an event in a device, means for placing the event in a local queue in the device and means for causing an event dissemination module in the device to disseminate the event from the local event queue to at least one other device.

Example 37 may include the elements of example 36, and may further comprise means for processing the event utilizing a processing module in the device.

Example 38 may include the elements of any of examples 36 to 37, wherein the means for causing the event dissemination module in the device to disseminate the event comprise means for incrementing a counter when the event is placed into the local queue.

Example 39 may include the elements of example 38, wherein the means for causing the event dissemination module in the device to disseminate the event comprise means for determining if multiple event dispatch paths exist in the device and means for, if multiple event dispatch paths are determined to exist in the device, determining at least one event dispatch path to utilize in disseminating the event.

Example 40 may include the elements of any of examples 38 to 39, wherein the means for causing the event dissemination module in the device to disseminate the event comprise means for triggering event dissemination operations based on incrementing the counter.

Example 41 may include the elements of any of examples 36 to 40, wherein the means for causing the event dissemination module in the device to disseminate the event comprise means for incrementing a counter when the event is placed into the local queue and means for triggering event dissemination operations based on incrementing the counter.

Example 42 may include the elements of any of examples 36 to 41, wherein the events are asynchronous events.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device to operate in a system for event dissemination, comprising:
a communication module to interact with a plurality of other devices;
a processing module to process at least events;
a local event queue; and
an event dissemination module to:
receive an event into the device;
place the event into the local event queue; and
disseminate the event from the local event queue to at least one other device in the plurality of other devices.

2. The device of claim 1, wherein the processing module is to:
generate a new event in the device; and
cause the communication module to transmit the new event to at least one device in the plurality of devices that is designated as a network dispatch location.

3. The device of claim 1, wherein the local queue resides in a memory in the event dissemination module or in a memory module in the device.

4. The device of claim 1, wherein the event dissemination module comprises at least a counter to increment when an event is placed into the local event queue.

5. The device of claim 4, wherein the event dissemination module comprises at least a trigger operation module to perform at least one activity when the counter increments.

6. The device of claim 5, wherein the at least one activity comprises disseminating the event from the local event queue to at least one other device in the plurality of other devices.

7. The device of claim 1, wherein in disseminating the event the event dissemination module is to cause the communication module to transmit a message including the event to the at least one other device.

8. The device of claim 1, wherein the device comprises at least one of a plurality of event dissemination modules or a plurality of local event queues corresponding to a plurality of event dispatch paths, respectively.

9. The device of claim 8, wherein the plurality of event dispatch paths each define a group of the plurality of devices through which events are disseminated.

10. A system for event dissemination, comprising:
a plurality of devices, each of the plurality of devices comprising:
a communication module to interact with other devices in the plurality of devices;
a processing module to process at least events;
a local event queue; and
an event dissemination module to:
receive an event into the device;
place the event into the local event queue; and
disseminate the event from the local event queue to at least one other device in the plurality of other devices.

11. The system of claim 11, wherein the system is a high performance computing system.

12. The system of claim 11, wherein at least one device in the plurality of devices is designated as a network dispatch location to which new events are transmitted for dissemination.

13. The system of claim 11, wherein each event dissemination module comprises at least a counter to increment when an event is placed into the local event queue.

14. The system of claim 13, wherein each event dissemination module comprises at least a trigger operation module to perform at least one activity when the counter increments.

15. The system of claim 14, wherein the at least one activity comprises disseminating the event from the local event queue to at least one other device in the plurality of other devices.

16. A method for event dissemination, comprising:
receiving an event in a device;
placing the event in a local queue in the device; and
causing an event dissemination module in the device to disseminate the event from the local event queue to at least one other device.

17. The method of claim 16, further comprising:
processing the event utilizing a processing module in the device.

18. The method of claim 16, wherein causing the event dissemination module in the device to disseminate the event comprises:
incrementing a counter when the event is placed into the local queue.

19. The method of claim 18, wherein causing the event dissemination module in the device to disseminate the event comprises:
determining if multiple event dispatch paths exist in the device; and
if multiple event dispatch paths are determined to exist in the device, determining at least one event dispatch path to utilize in disseminating the event.

20. The method of claim 18, wherein causing the event dissemination module in the device to disseminate the event comprises:
triggering event dissemination operations based on incrementing the counter.

21. At least one machine-readable storage medium having stored thereon, individually or in combination, instructions for event dissemination that, when executed by one or more processors, cause the one or more processors to:
receive an event in a device;
place the event in a local queue in the device; and
cause an event dissemination module in the device to disseminate the event from the local event queue to at least one other device.

22. The medium of claim 21, further comprising instructions that, when executed by one or more processors, cause the one or more processors to:
process the event utilizing a processing module in the device.

23. The medium of claim 21, wherein the instructions to cause the event dissemination module in the device to disseminate the event comprise instructions to:
increment a counter when the event is placed into the local queue.

24. The medium of claim 23, wherein the instructions to cause the event dissemination module in the device to disseminate the event comprise instructions to:
determine if multiple event dispatch paths exist in the device; and
if multiple event dispatch paths are determined to exist in the device, determine at least one event dispatch path to utilize in disseminating the event.

25. The medium of claim 23, wherein the instructions to cause the event dissemination module in the device to disseminate the event comprise instructions to:
trigger event dissemination operations based on incrementing the counter.
